(19) United States
(12) Patent Application Publication
(10) Pub. No.: US 2026/0253592 A1
(43) Pub. Date: Aug. 27, 2026

(54) SPEECH TEXT GENERATION METHOD, METHOD OF TRAINING SPEECH TEXT GENERATION MODEL, DEVICE AND MEDIUM

(71) Applicant: JINGDONG TECHNOLOGY INFORMATION TECHNOLOGY CO., LTD., Beijing (CN)

(72) Inventors: Mingchao FENG, Beijing (CN); Meng CHEN, Beijing (CN); Jie QIN, Beijing (CN)

(21) Appl. No.: 18/863,926

(22) PCT Filed: Apr. 12, 2023
(86) PCT No.: PCT/CN2023/087793

§ 371 Date: Nov. 7, 2024

(30) Foreign Application Priority Data
Oct. 9, 2022 (CN) 202211231004.1

(51) Int. Cl. G10L 15/26; G06F 40/166; G10L 15/06; G10L 15/16; G10L 15/18

(52) U.S. Cl. CPC G10L 15/26; G06F 40/166; G10L 15/063; G10L 15/16; G10L 15/1815; G10L 15/1822; G10L 2015/0635

(57) ABSTRACT

The present disclosure provides a speech text generation method applied to fields of artificial intelligence technology and intelligent customer service technology. The speech text generation method includes: performing a part-of-speech tagging on a standard text to obtain a part-of-speech tagging result; determining a target part-of-speech from the part-of-speech tagging result according to a distribution feature of modal particles; determining a predicted insertion position according to a position of a content corresponding to the target part-of-speech in the standard text; inserting a target modal particle into the standard text according to the predicted insertion position to obtain a target spoken text; and generating a target speech text according to the target spoken text. The present disclosure further provides a method of training a speech text generation model, a speech text generation apparatus, an apparatus of training a speech text generation model, a device, a medium, and a program product.

### CROSS REFERENCE TO RELATED APPLICATION(S)

This application is a Section 371 National Stage Application of International Application No. PCT/CN2023/087793, filed on Apr. 12, 2023, and entitled “SPEECH TEXT GENERATION METHOD AND APPARATUS, METHOD AND APPARATUS OF TRAINING SPEECH TEXT GENERATION MODEL”, which claims the benefit of priority to Chinese Patent Application No. 202211231004.1, filed on Oct. 9, 2022. The entire contents of this application are hereby incorporated herein by reference.

### TECHNICAL FIELD

The present disclosure relates to fields of artificial intelligence technology and intelligent customer service technology, and more specifically, to a speech text generation method, a method of training a speech text generation model, a device, and a medium.

### BACKGROUND

With the development of artificial intelligence technology, application scenarios of intelligent dialogue systems are becoming more and more extensive. The Intelligent dialogue systems automatically generate service-related intelligent speech information, or generate intelligent reply information based on user speech information, so as to implement automatic speech interaction with users by using the intelligent dialogue systems to meet the relevant desires of users.

### SUMMARY

The present disclosure provides a speech text generation method, a method of training a speech text generation model, a device, and a medium.

An aspect of the present disclosure provides a speech text generation method, including: performing a part-of-speech tagging on a standard text to obtain a part-of-speech tagging result; determining a target part-of-speech from the part-of-speech tagging result according to a distribution feature of modal particles; determining a predicted insertion position according to a position of a content corresponding to the target part-of-speech in the standard text; inserting a target modal particle into the standard text according to the predicted insertion position to obtain a target spoken text; and generating a target speech text according to the target spoken text.

According to embodiments of the present disclosure, the inserting a target modal particle into the standard text according to the predicted insertion position to obtain a target spoken text includes: masking the predicted insertion position of the standard text to obtain a masked standard text; and inputting the masked standard text into a speech text generation model, so that the speech text generation model inserts the target modal particle at a target insertion position in the predicted insertion position to generate the target spoken text.

According to embodiments of the present disclosure, the speech text generation method further includes: acquiring an initial corpus set, wherein the initial corpus set includes an initial spoken corpus text generated based on a spoken speech corpus; performing a part-of-speech tagging on the initial spoken corpus text to obtain a spoken corpus part-of-speech tagging result and a spoken corpus modal particle tagging result; and determining the distribution feature of modal particles based on the spoken corpus part-of-speech tagging result and the spoken corpus modal particle tagging result.

According to embodiments of the present disclosure, the performing a part-of-speech tagging on a standard text to obtain a part-of-speech tagging result includes: inputting the standard text into a semantic recognition model to obtain the part-of-speech tagging result; wherein the semantic recognition model includes: a first semantic recognition model constructed based on a recurrent neural network model and a conditional random field model; or a second semantic recognition model constructed based on a dependency syntactic parsing.

Another aspect of the present disclosure further provides a method of training a speech text generation model, including: performing a part-of-speech tagging on a training sample standard text in a training sample set and a training sample spoken text in the training sample set, so as to obtain a first sample part-of-speech tagging result of the training sample standard text, a second sample part-of-speech tagging result of the training sample spoken text, and a sample modal particle tagging result of the training sample spoken text, wherein the training sample spoken text is associated with the training sample standard text; determining a sample target part-of-speech from the first sample part-of-speech tagging result according to a distribution feature of sample modal particles; determining a sample predicted insertion position according to a position of a sample content corresponding to the sample target part-of-speech in the training sample standard text; masking the sample predicted insertion position in the training sample standard text to obtain a training sample masked standard text, wherein the training sample masked standard text has the first sample part-of-speech tagging result; and training an initial speech text generation model using a target training set to obtain a trained speech text generation model, wherein the target training set includes the training sample masked standard text, the second sample part-of-speech tagging result of the training sample spoken text, and the sample modal particle tagging result of the training sample spoken text.

According to embodiments of the present disclosure, the training method further includes: updating a first sample standard text in a first sample set and a first sample spoken text in the first sample set by using a sample confusion word in a sample confusion dictionary, so as to obtain a second sample set comprising a second sample standard text and a second sample spoken text, wherein the first sample spoken text is associated with the first sample standard text; and constructing the training sample set based on the first sample set and the second sample set.

According to embodiments of the present disclosure, the training method further includes: processing a sample standard corpus text using a speech synthesis apparatus to obtain a sample speech corpus; performing a speech recognition on the sample speech corpus to obtain a sample confusion corpus text; and constructing the sample confusion dictionary based on the sample standard corpus text and the sample confusion corpus text.

According to embodiments of the present disclosure, the training method further includes: acquiring a sample initial corpus set, wherein the sample initial corpus set includes a sample initial spoken corpus text generated according to a sample spoken speech corpus; performing a part-of-speech tagging on the sample initial spoken corpus text to obtain a sample spoken corpus part-of-speech tagging result and a sample spoken corpus modal particle tagging result; and determining the distribution feature of sample modal particles according to the sample spoken corpus part-of-speech tagging result and the sample spoken corpus modal particle tagging result.

Another aspect of the present disclosure provides an electronic device, including: one or more processors; and a memory configured to store one or more programs, wherein the one or more programs, when executed by the one or more processors, are configured to cause the one or more processors to implement the above methods.

Another aspect of the present disclosure provides a non-transitory computer-readable storage medium having executable instructions therein, wherein the instructions, when executed by a processor, are configured to cause the processor to implement the above methods.

### BRIEF DESCRIPTION OF THE DRAWINGS

The above and other purposes, features and advantages of the present disclosure will become clearer through the following description of embodiments of the present disclosure with reference to the accompanying drawings, in which:

FIG. 1 schematically shows an exemplary system architecture to which a speech text generation method and a speech text generation apparatus may be applied according to embodiments of the present disclosure;

FIG. 2 schematically shows a flow chart of a speech text generation method according to embodiments of the present disclosure;

FIG. 3 schematically shows a flow chart of a speech text generation method according to another embodiment of the present disclosure;

FIG. 4 schematically shows a flow chart of inserting a target modal particle into a standard text according to a predicted insertion position to obtain a target spoken text according to embodiments of the present disclosure;

FIG. 5 schematically shows an application scenario diagram of a speech text generation method according to embodiments of the present disclosure;

FIG. 6 schematically shows a flow chart of a method of training a speech text generation model according to embodiments of the present disclosure;

FIG. 7 schematically shows a block diagram of a speech text generation apparatus according to embodiments of the present disclosure;

FIG. 8 schematically shows a block diagram of an apparatus of training a speech text generation model according to embodiments of the present disclosure; and

FIG. 9 schematically shows a block diagram of an electronic device suitable for implementing a speech text generation method and a method of training a speech text generation model according to embodiments of the present disclosure.

### DETAILED DESCRIPTION OF EMBODIMENTS

Embodiments of the present disclosure will be described below with reference to the accompanying drawings. It should be understood that these descriptions are merely exemplary and are not intended to limit the scope of the present disclosure. In the following detailed descriptions, for purposes of explanation, numerous specific details are set forth in order to provide a thorough understanding of embodiments of the present disclosure. It is clear that one or more embodiments may be implemented without these specific details. In addition, in the following descriptions, descriptions of well-known structures and technologies are omitted to avoid unnecessarily obscuring the concept of the present disclosure.

Terms used herein are for the purpose of describing embodiments only and are not intended to limit the present disclosure. Terms “comprising”, “including” and the like used herein specify a presence of the feature, step, operation and/or component, but do not preclude a presence or addition of one or more other features, steps, operations or components.

All terms (including technical and scientific terms) used herein have the same meaning as commonly understood by those skilled in the art, unless otherwise defined. It should be noted that the terms used herein should be construed to have meanings consistent with the context of the present description and should not be construed in an idealized or overly rigid manner.

Where expressions like “at least one of A, B, or C, etc.” are used, they should generally be interpreted in accordance with the meaning of the expression as commonly understood by those skilled in the art (e.g., “a system having at least one of A, B or C” should include, but is not limited to, a system having A alone, having B alone, having C alone, having A and B, having A and C, having B and C, and/or having A, B, C, etc.).

The speech information generated by the intelligent dialogue system is usually generated based on written text, which ignores the modal particles, hesitation words, and restatement words that may exist in real-life conversations between people. Therefore, although the speech information generated by speech synthesis apparatus or manual translation is very standard, it is very stiff and dull, which is quite different from the speech information generated in normal human conversations, and may easily make users feel that they are talking to a machine, thereby reducing the user experience.

Embodiments of the present disclosure provide a speech text generation method, a method of training a speech text generation model, a speech text generation apparatus, an apparatus of training a speech text generation model, a device, a medium, and a program product. The speech text generation method includes: performing a part-of-speech tagging on a standard text to obtain a part-of-speech tagging result; determining a target part-of-speech from the part-of-speech tagging result according to a distribution feature of modal particles; determining a predicted insertion position according to a position of a content corresponding to the target part-of-speech in the standard text; inserting a target modal particle into the standard text according to the predicted insertion position to obtain a target spoken text; and generating a target speech text according to the target spoken text.

According to embodiments of the present disclosure, after the part-of-speech tagging is performed on the standard text and the part-of-speech tagging result is obtained, the part-of-speech of each standard word in the standard text may be obtained according to the part-of-speech tagging result, and the predicted insertion position where a modal particle may be inserted is determined from the part-of-speech tagging result according to the distribution feature of modal particles, and the target modal particle is inserted into the standard text according to the predicted insertion position, so that the obtained target spoken text have the colloquial characteristics of normal human conversation, and the target speech text generated according to the target spoken text may at least partially solve the technical problem that the intelligent speech information is relatively stiff and dull which is quite different from human conversation in the related art. Therefore, the target speech text in the present disclosure may have colloquial characteristics closer to those in the speech information of human conversation, and the target speech text has anthropomorphic characteristics, thereby enhancing the user experience in speech interaction.

In the technical solution of the present disclosure, the authorization or consent of user is obtained before obtaining or collecting the personal information of user.

In the technical solution of the present disclosure, the collection, storage, use, processing, transmission, provision, disclosure and application of the user personal information involved are in compliance with the provisions of relevant laws and regulations, necessary confidentiality measures are taken, and do not violate public order and good customs.

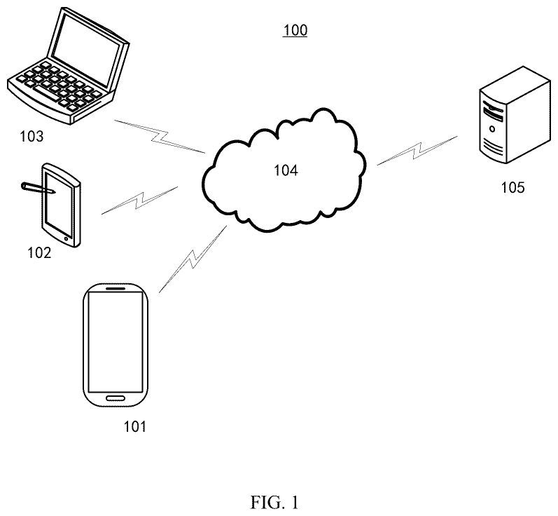

FIG. 1 schematically shows an exemplary system architecture to which a speech text generation method and a speech text generation apparatus may be applied according to embodiments of the present disclosure. It should be noted that FIG. 1 is only an example of a system architecture to which embodiments of the present disclosure may be applied, in order to help those skilled in the art understand the technical content of the present disclosure, but does not mean that embodiments of the present disclosure may not be used in other devices, systems, environments or scenarios.

As shown in FIG. 1, the system architecture 100 according to embodiments may include terminal devices 101, 102, and 103, a network 104, and a server 105. The network 104 is used to provide a medium for a communication link between the terminal devices 101, 102, and 103 and the server 105. The network 104 may include various connection types, such as wired and/or wireless communication links, etc.

The terminal devices 101, 102, and 103 may be used by users to interact with the server 105 through the network 104 to receive or send messages, etc. Various communication client applications may be installed on the terminal devices 101, 102, and 103, such as shopping applications, web browser applications, search applications, instant messaging tools, email clients, and/or social platform software, etc. (only as examples).

The terminal devices 101, 102, and 103 may be various electronic devices with display screens and supporting web browsing, including but not limited to smart phones, tablet computers, laptop computers, and desktop computers.

The server 105 may be a server that provides various services, such as a background management server (only as an example) that provides support for websites browsed by users using terminal devices 101, 102, and 103. The background management server may analyze and process the received data such as user requests, and feed back the processing results (such as web pages, information, or data obtained or generated according to user requests) to the terminal devices.

It should be noted that the speech text generation method in embodiments of the present disclosure may generally be performed by the server 105. Correspondingly, the speech text generation apparatus in embodiments of the present disclosure may generally be provided in the server 105. The speech text generation method in embodiments of the present disclosure may also be performed by a server or server cluster that is different from the server 105 and may communicate with the terminal devices 101, 102, and 103 and/or the server 105. Correspondingly, the speech text generation apparatus in embodiments of the present disclosure may also be provided in a server or server cluster that is different from the server 105 and may communicate with the terminal devices 101, 102, and 103 and/or the server 105. Alternatively, the speech text generation method in embodiments of the present disclosure may also be performed by the terminal device 101, 102, or 103, or may also be performed by other terminal device different from the terminal device 101, 102, or 103. Correspondingly, the speech text generation apparatus in embodiments of the present disclosure may also be provided in the terminal device 101, 102 or 103, or in other terminal device different from the terminal device 101, 102 or 103.

For example, the standard text may be originally stored in any one of the terminal devices 101, 102, and 103 (for example, the terminal device 101, but not limited thereto), or stored on an external storage device and may be imported into the terminal device 101. Then, the terminal device 101 may locally perform the speech text generation method in embodiments of the present disclosure; or send the standard text to other terminal devices, servers, or server clusters, and the speech text generation method in embodiments of the present disclosure may be performed by other terminal devices, servers, or server clusters that receive the standard text.

It should be understood that the number of terminal devices, the number of networks, and the number of servers shown in FIG. 1 are merely illustrative. Any number of terminal devices, any number of networks, and any number of servers may be set as desires for implementation.

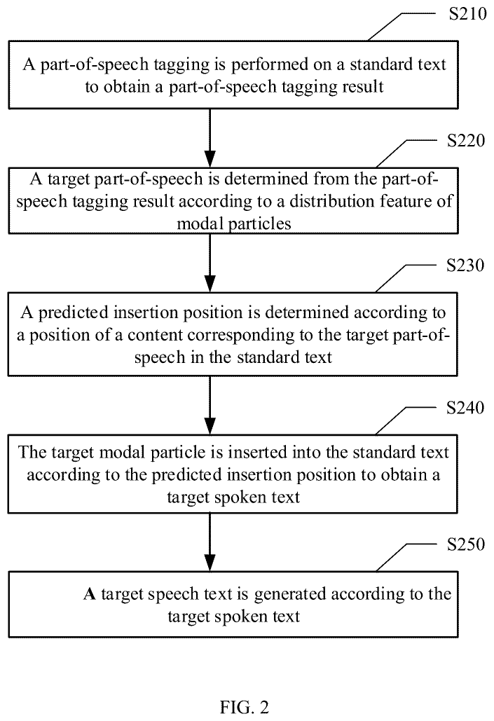

FIG. 2 schematically shows a flow chart of a speech text generation method according to embodiments of the present disclosure.

As shown in FIG. 2, the method includes operations S210 to S250.

In operation S210, a part-of-speech tagging is performed on a standard text to obtain a part-of-speech tagging result.

According to embodiments of the present disclosure, the standard text may include a text used for written communication, such as a standard customer service staff response text, an email body text, etc.

It should be noted that the standard customer service staff response text may be applied to an intelligent customer service Q&A apparatus, which generates a corresponding speech text based on the standardized standard customer service staff response text, thereby implementing the speech interaction with the user, however, the generated speech text is usually stiff and rigid, which is too different from human conversation speech and does not have the colloquial characteristics.

According to embodiments of the present disclosure, the part-of-speech tagging is performed on the standard text, and the obtained part-of-speech tagging result may include the standard word generated after performing the word segmentation on the standard text and the part-of-speech feature of the standard word. The part-of-speech feature may include, for example, adjective part-of-speech, verb part-of-speech, etc.

It should be noted that embodiments of the present disclosure do not limit the specific method of part-of-speech tagging. For example, a network model constructed based on a neural network may be used to tag the standard text with the part-of-speech, but the present disclosure is not limited to this. A semantic recognition model constructed based on a statistical algorithm may also be used to tag the standard text with the part-of-speech. Embodiments of the present disclosure do not limit the specific technical means of part-of-speech tagging, and those skilled in the art may make a choice according to actual conditions.

In operation S220, a target part-of-speech is determined from the part-of-speech tagging result according to a distribution feature of modal particles.

According to embodiments of the present disclosure, the modal particle may include one or more words that express a human emotion such as hesitation, doubt, or the like, for example “um”, “just”, “for one”, “like”, etc., but the present disclosure is not limited to this. The modal particle may also include polite words that are expressed at the beginning and/or end of human speech dialogues, such as “if you are free”, “if you like”, etc.

According to embodiments of the present disclosure, the part-of-speech of the word adjacent to the modal particle in the dialogue text may be determined based on a large amount of dialogue text, so as to determine the distribution feature of the modal particles, so that the target part-of-speech in the standard text may be predicted according to the distribution feature of the modal particles.

In embodiments of the present disclosure, the target part-of-speech may include a verb part-of-speech and an adjective part-of-speech.

In operation S230, a predicted insertion position is determined according to a position of a content corresponding to the target part-of-speech in the standard text.

According to embodiments of the present disclosure, after the target part-of-speech is determined, the predicted insertion position may be determined according to the part-of-speech feature of the standard word in the standard text, and the predicted insertion position may be a position adjacent to the position of the standard word having the target part-of-speech.

In operation S240, the target modal particle is inserted into the standard text according to the predicted insertion position to obtain a target spoken text.

According to embodiments of the present disclosure, if there are a plurality of predicted insertion positions, a corresponding target modal particle may be inserted into each predicted insertion position, or the target modal particle may be inserted at a target insertion position among the predicted insertion positions. After inserting the target modal particle into the standard text, the target spoken text may have enhanced colloquial characteristics without changing the semantic information of the standard text.

In operation S250, a target speech text is generated according to the target spoken text.

According to embodiments of the present disclosure, the target speech text may be speech information, and the target spoken text may be converted into the target speech text by using a related speech synthesis device, and the target speech text may be generated according to the target spoken text.

According to embodiments of the present disclosure, after the standard text is performed with the part-of-speech tagging and the part-of-speech tagging result is obtained, the part-of-speech of each standard word in the standard text may be obtained according to the part-of-speech tagging result, and the predicted insertion position where the modal particle may be inserted is determined from the part-of-speech tagging result according to the distribution feature of modal particles, and the target modal particle is inserted into the standard text according to the predicted insertion position, so that the obtained target spoken text has the colloquial characteristics of normal human conversation, the target speech text generated according to the target spoken text may at least partially solve the technical problem that the intelligent speech information is relatively stiff and dull which is greatly different from human conversation in the related art. Therefore, the target speech text in the present disclosure may have colloquial characteristics closer to those in the speech information of human conversation, and the target speech text has anthropomorphic characteristics, thereby enhancing the user experience in the speech interaction.

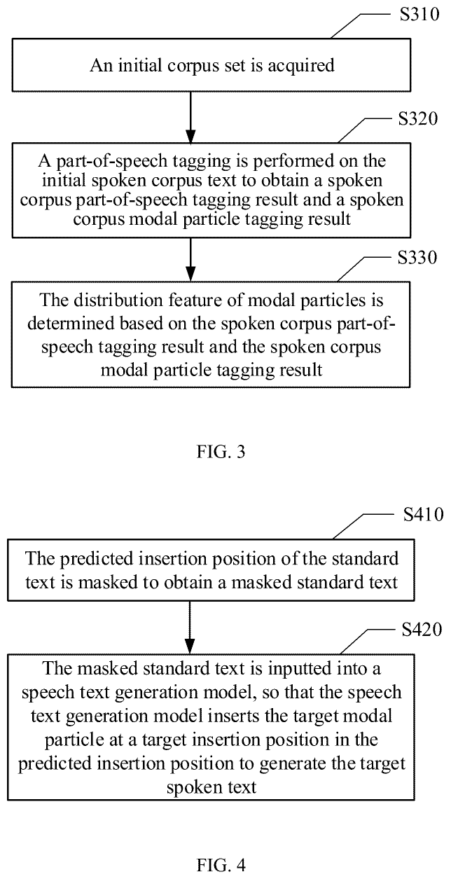

FIG. 3 schematically shows a flow chart of a speech text generation method according to another embodiment of the present disclosure.

As shown in FIG. 3, the speech text generation method may include operations S310 to S330.

In operation S310, an initial corpus set is acquired. The initial corpus set includes an initial spoken corpus text generated based on a spoken speech corpus.

In operation S320, a part-of-speech tagging is performed on the initial spoken corpus text to obtain a spoken corpus part-of-speech tagging result and a spoken corpus modal particle tagging result.

In operation S330, the distribution feature of modal particles is determined based on the spoken corpus part-of-speech tagging result and the spoken corpus modal particle tagging result.

According to embodiments of the present disclosure, the initial spoken corpus text may include, for example, a corpus text generated according to the conversational speech information in a real human conversation scene, and the corpus text includes the text of the conversational speech information, that is, the initial spoken corpus text contains the spoken corpus modal particle that humans habitually use. By performing the part-of-speech tagging on the initial spoken corpus text, the part-of-speech of the spoken corpus word in the initial spoken corpus text may be obtained, and a positional relationship between the spoken corpus modal particle and each spoken corpus word may also be obtained. By analyzing and determining the positional relationship, the distribution feature of the spoken corpus modal particles may be determined, that is, the distribution feature of the modal particles in the spoken speech information may be determined.

For example, the distribution feature of the modal particles may represent that the statistical probability of the position after the spoken corpus word having the verb part-of-speech is 0.9, and the statistical probability of the position before the spoken corpus word having the adjective part-of-speech is 0.8. By determining the statistical probabilities of these positions, the distribution feature of the modal particles is determined.

According to embodiments of the present disclosure, a position probability threshold may be set. For a position, if the statistical probability threshold of the position is greater than or equal to the position probability threshold, then the statistical probability threshold is used as the distribution statistical probability in the distribution feature of modal particles.

It should be noted that “before” in embodiments of the present disclosure refers to that the position is adjacent to the position of the spoken corpus word and is located before the position of the spoken corpus word, and correspondingly, “after” refers to that the position is adjacent to the position of the spoken corpus word and is located after the position of the spoken corpus word.

According to embodiments of the present disclosure, in operation S210, performing the part-of-speech tagging on the standard text to obtain the part-of-speech tagging result may include the following operations.

The standard text is input into a semantic recognition model to obtain the part-of-speech tagging result. The semantic recognition model includes: a first semantic recognition model constructed based on a recurrent neural network model and a conditional random field model; or a second semantic recognition model constructed based on a dependency syntactic parsing.

According to embodiments of the present disclosure, the first semantic recognition model may be constructed by sequentially connecting a recurrent neural network model (RNN model) and a conditional random field model (CRF model), or may be constructed by sequentially connecting a bidirectional long short-term memory network model (Bi-LSTM model) and a conditional random field model (CRF model).

It should be understood that the recurrent neural network model may include a long short-term memory network model (LSTM model), and a bidirectional long short-term memory network model (Bi-LSTM model), and those skilled in the art may design the specific network structure of the first semantic recognition model according to actual desires.

According to embodiments of the present disclosure, the second semantic recognition model constructed based on dependency syntactic parsing may include, for example, an LTP (Language Technology Platform) language processing system, etc.

FIG. 4 schematically shows a flow chart of inserting a target modal particle into a standard text according to a predicted insertion position to obtain a target spoken text according to embodiments of the present disclosure.

As shown in FIG. 4, in operation S240, the inserting a target modal particle into a standard text according to a predicted insertion position to obtain a target spoken text includes operations S410 to S420.

In operation S410, the predicted insertion position of the standard text is masked to obtain a masked standard text.

In operation S420, the masked standard text is inputted into a speech text generation model, so that the speech text generation model inserts the target modal particle at a target insertion position in the predicted insertion position to generate the target spoken text.

According to embodiments of the present disclosure, the speech text generation model may be constructed based on the BERT model, for example, it may include the BERT-WWM model. The masked standard text is input into the BERT-WWM model to further iteratively predict the mask of the predicted insertion position, thereby determining the target predicted position from the predicted insertion position, and determining the target modal particle at each target predicted position from the modal particle set based on the prediction ability of the BERT-WWM model, so as to achieve the generation of the target spoken text.

It should be noted that the speech text generation model may be obtained after training with a relevant training method. When the speech text generation model is a BERT-WWM model, at least one of the standard words in the masked standard text may be replaced with synonyms or homophones based on the prediction ability of the BERT-WWM model, thereby further enhancing the colloquial characteristics of the target spoken text.

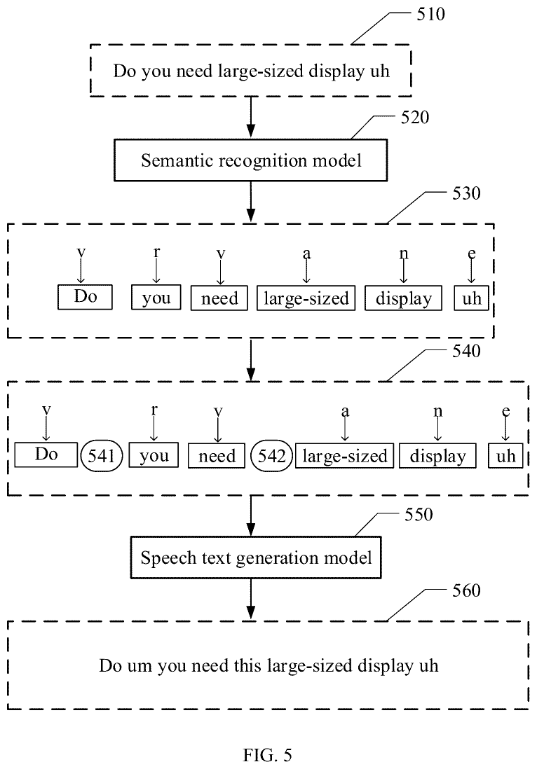

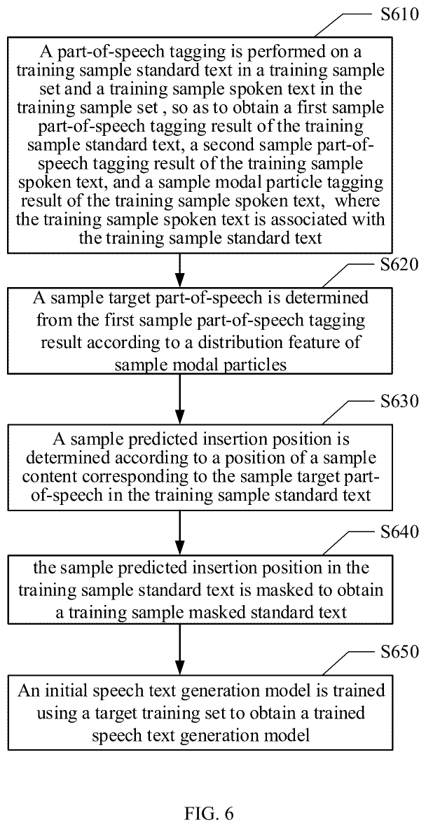

FIG. 5 schematically shows an application scenario diagram of a speech text generation method according to embodiments of the present disclosure.

As shown in FIG. 5, the application scenario may include a standard text 510 “Do you need large-sized display uh” The standard text 510 is input into a semantic recognition model 520, and the part-of-speech tagging of the standard text may be implemented to obtain a part-of-speech tagging result 530.

In embodiments of the present disclosure, the semantic recognition model 520 may be constructed by sequentially connecting a bidirectional long short-term memory network model (Bi-LSTM model) and a conditional random field model (CRF model).

The part-of-speech tagging result 530 may include the standard words “Do”, “you”, “need”, “large-sized”, “display”, and “uh” in the standard text 510. The part-of-speech tagging result 530 may further include the part-of-speech of each standard word. “v” represents the verb part-of-speech, “r” represents the pronoun part-of-speech, “a” represents the adjective part-of-speech, “n” represents the noun part-of-speech, and “e” represents the modal particle part-of-speech.

According to the distribution feature of modal particles, the target part-of-speech may be determined from the part-of-speech tagging result 530 as a verb part-of-speech and an adjective part-of-speech. According to the content corresponding to the target part-of-speech, the predicted insertion position after the verb part-of-speech standard word “Do” and the predicted insertion position after the verb part-of-speech standard word “need” and before the adjective part-of-speech standard word “large-sized” in the standard text 510 are determined. Each predicted insertion position is masked to obtain a masked standard text 540. The masked standard text 540 may include mask units 541 and 542 corresponding to the predicted insertion positions.

The masked standard text 540 is input into the speech text generation model 550, the speech text generation model may determine the predicted insertion position as the target predicted insertion position, and insert the target modal particle “um” into the mask unit 541 corresponding to the target predicted insertion position, and insert the target modal particle “this” into the mask unit 542 corresponding to the target predicted insertion position, thereby generating a target spoken text 560 “Do um you need this large-sized display uh” Therefore, the target spoken text 560 may have colloquial characteristics close to human spoken speech information, and the target speech text generated according to the target spoken text 560 may have colloquial characteristics, which may at least partially avoid the stiffness and dullness of the generated speech information, and reduce the difference with the speech information of human conversation.

FIG. 6 schematically shows a flow chart of a method of training a speech text generation model according to embodiments of the present disclosure.

As shown in FIG. 6, the method includes operations S610 to S650.

In operation S610, a part-of-speech tagging is performed on a training sample standard text in a training sample set and a training sample spoken text in the training sample set, so as to obtain a first sample part-of-speech tagging result of the training sample standard text, a second sample part-of-speech tagging result of the training sample spoken text, and a sample modal particle tagging result of the training sample spoken text, where the training sample spoken text is associated with the training sample standard text.

In operation S620, a sample target part-of-speech is determined from the first sample part-of-speech tagging result according to a distribution feature of sample modal particles.

In operation S630, a sample predicted insertion position is determined according to a position of a sample content corresponding to the sample target part-of-speech in the training sample standard text.

In operation S640, the sample predicted insertion position in the training sample standard text is masked to obtain a training sample masked standard text, where the training sample masked standard text has the first sample part-of-speech tagging result.

In operation S650, an initial speech text generation model is trained using a target training set to obtain a trained speech text generation model, where the target training set includes the training sample masked standard text, the second sample part-of-speech tagging result of the training sample spoken text, and the sample modal particle tagging result of the training sample spoken text.

According to embodiments of the present disclosure, the training sample standard text may include a standard written text, and the training sample spoken text may include a spoken text converted from the speech information generated after the sample user transcribes the pronunciation of the training sample standard text. As the training sample spoken text is generated based on the transcribed speech by the sample user, the training sample spoken text may contain a sample modal particle. This at least partially solves the problem of using the standard text to train the speech text generation model so that the trained speech text generation model cannot learn the characteristics of modal particles, hesitation words and the like that may exist in the spoken dialogue expression in the related art.

According to embodiments of the present disclosure, a training sample masked standard text and a training sample spoken text may be combined into a training sample pair, and a similarity label value may be determined according to the similarity between the training sample masked standard text and the training sample spoken text in the training sample pair. The similarity label value may be used to iteratively adjust the weight parameter of the initial speech text generation model, so that the generated speech text generation model may predict the positional relationship between the sample modal particle and the first sample part-of-speech tagging result of the training sample standard text, so that the target insertion position may be accurately determined according to the predicted insertion position, and the target sample modal particle may be determined from the sample modal particle.

It should be noted that the speech text generation model trained by using the method of training a speech text generation model provided by embodiments of the present disclosure may be used in the speech text generation method.

According to embodiments of the present disclosure, the method of training a speech text generation model further includes the following operations.

The first sample standard text and the first sample spoken text associated with the first sample standard text in the first sample set are updated using a sample confusion word in the sample confusion dictionary, so as to obtain a second sample set including the second sample standard text and the second sample spoken text; and a training sample set is constructed according to the first sample set and the second sample set.

According to embodiments of the present disclosure, the sample confusion dictionary may include a sample confusion word pair consisting of the sample standard word and the sample confusion word. By replacing the sample standard word in the first sample standard text with the sample confusion word in the sample confusion dictionary, and by replacing the sample standard word in the first sample spoken text with the sample confusion word in the sample confusion dictionary, a large number of second sample standard texts and second sample spoken texts may be obtained respectively, so that a training sample set may be constructed according to the first sample set and the second sample set, and the number of training sample data may be expanded to enhance the training ability of the training sample set. Further, by training the initial speech text generation model with the training sample set including the first sample set and the second sample set, the initial speech text generation model may fully learn the similar association between the standard word and the confusion word, so that the speech text generation model obtained after training may automatically replace the standard word in the standard text with the sample confusion word, thereby further enriching the semantic expression of the target spoken text and making the target spoken text have the colloquial characteristics closer to those in the normal human conversation.

According to embodiments of the present disclosure, the method of training a speech text generation model may further include the following operations.

A sample standard corpus text is processed by using a speech synthesis apparatus to obtain a sample speech corpus. The speech recognition is performed on the sample speech corpus to obtain a sample confusion corpus text. A sample confusion dictionary is constructed based on the sample standard corpus text and the sample confusion corpus text.

According to embodiments of the present disclosure, the sample standard corpus text may include a text used for written communication, such as standard customer service staff response text, email body text, etc. The sample speech corpus may include speech information generated after the speech synthesis apparatus automatically recognizes the sample standard corpus text. By using a speech recognition (Automatic Speech Recognition, ASR) apparatus to recognize the sample speech corpus, the recognized sample confusion corpus text may be obtained. Due to the recognition capability limitation of the speech recognition apparatus, at least one of the sample standard words in the sample standard corpus text may be recognized as sample confusion word, so that the sample confusion corpus text contains the sample confusion word recognized by the speech recognition apparatus. According to the comparison result of the sample standard corpus text and the sample confusion corpus text, the sample standard word and the sample confusion word may be combined into the sample confusion word pair, and then the sample confusion dictionary may be constructed.

According to embodiments of the present disclosure, after performing the speech recognition on the sample speech corpus using the speech recognition apparatus, a confidence information of the initial sample confusion corpus text output by the speech recognition apparatus is determined, and the initial sample confusion corpus text with confidence information less than or equal to a preset confidence threshold is determined as the sample confusion corpus text, so that the sample confusion word that is easily misrecognized may be selected according to the sample confusion corpus text, so that the sample confusion word pair of the constructed sample confusion dictionary more accurately reflect the association features of the sample confusion word and the sample standard word.

According to embodiments of the present disclosure, the method of training a speech text generation model may further include the following operations.

A sample initial corpus set is acquired. The sample initial corpus set includes a sample initial spoken corpus text generated according to a sample spoken speech corpus. A part-of-speech tagging is performed on the sample initial spoken corpus text to obtain a sample spoken corpus part-of-speech tagging result and a sample spoken corpus modal particle tagging result. The distribution feature of sample modal particles is determined according to the sample spoken corpus part-of-speech tagging result and the sample spoken corpus modal particle tagging result.

According to embodiments of the present disclosure, the sample initial spoken corpus text may include, for example, a corpus text generated according to the conversation speech information in a real human conversation scene, and the corpus text includes the text of the conversation speech information, that is, the sample initial spoken corpus text contains spoken corpus modal particles that humans habitually use. By performing the part-of-speech tagging on the sample initial spoken corpus text, the part-of-speech of the sample spoken corpus word in the sample initial spoken corpus text may be obtained, and the positional relationship between the sample spoken corpus modal particle and each sample spoken corpus word may also be obtained. By analyzing and determining the positional relationship, the distribution feature of the sample spoken corpus modal particles may be determined, that is, the distribution feature of the sample modal particles in the sample spoken speech information may be determined.

It should be noted that the speech text generation model trained by the method of training a speech text generation model provided in embodiments of the present disclosure may be used in the speech text generation method.

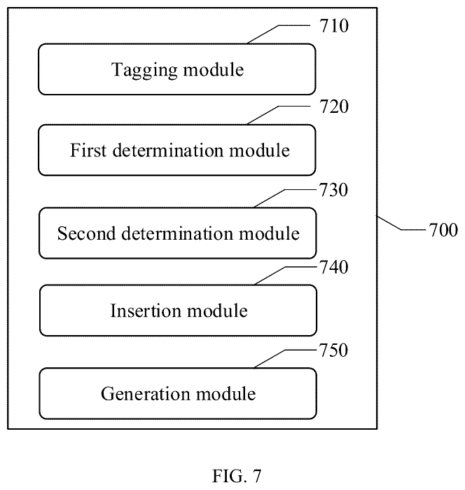

FIG. 7 schematically shows a block diagram of a speech text generation apparatus according to embodiments of the present disclosure.

As shown in FIG. 7, the speech text generation apparatus 700 may include a tagging module 710, a first determination module 720, a second determination module 730, an insertion module 740, and a generation module 750.

The tagging module 710 is used to perform a part-of-speech tagging on a standard text to obtain a part-of-speech tagging result.

The first determination module 720 is used to determine a target part-of-speech from the part-of-speech tagging result according to a distribution feature of modal particles.

The second determination module 730 is used to determine a predicted insertion position according to a position of a content corresponding to the target part-of-speech in the standard text.

The insertion module 740 is used to insert a target modal particle into the standard text according to the predicted insertion position to obtain a target spoken text.

The generation module 750 is used to generate a target speech text according to the target spoken text.

According to embodiments of the present disclosure, the insertion module may include: a mask unit and a generation unit.

The mask unit is used to mask the predicted insertion position of the standard text to obtain a masked standard text.

The generation unit is used to input the masked standard text into a speech text generation model, so that the speech text generation model inserts the target modal particle at a target insertion position in the predicted insertion position to generate the target spoken text.

According to embodiments of the present disclosure, the speech text generation method may further include: an acquisition module, a corpus tagging module and a third determination module.

The acquisition module is used to acquire an initial corpus set. The initial corpus set includes an initial spoken corpus text generated based on a spoken speech corpus.

The corpus tagging module is used to perform a part-of-speech tagging on the initial spoken corpus text to obtain a spoken corpus part-of-speech tagging result and a spoken corpus modal particle tagging result.

The third determination module is used to determine the distribution feature of modal particles based on the spoken corpus part-of-speech tagging result and the spoken corpus modal particle tagging result.

According to embodiments of the present disclosure, the tagging module may include a tagging unit.

The tagging unit is used to input the standard text into a semantic recognition model to obtain the part-of-speech tagging result.

The semantic recognition model includes: a first semantic recognition model constructed based on a recurrent neural network model and a conditional random field model; or a second semantic recognition model constructed based on a dependency syntactic parsing.

It should be noted that the part of the speech text generation apparatus in embodiments of the present disclosure corresponds to the part of the speech text generation method in embodiments of the present disclosure. The description of the part of the speech text generation apparatus specifically refers to the part of the speech text generation method, which will not be repeated here.

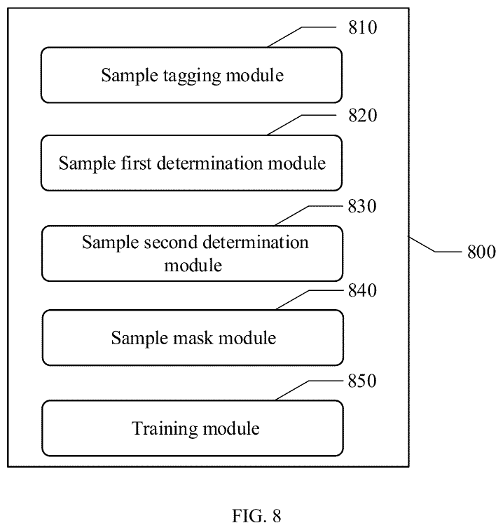

FIG. 8 schematically shows a block diagram of an apparatus of training a speech text generation model according to embodiments of the present disclosure.

As shown in FIG. 8, the apparatus 800 of training a speech text generation model may include a sample tagging module 810, a sample first determination module 820, a sample second determination module 830, a sample mask module 840, and a training module 850.

The sample tagging module 810 is used to perform a part-of-speech tagging on a training sample standard text in a training sample set and a training sample spoken text in the training sample set, so as to obtain a first sample part-of-speech tagging result of the training sample standard text, a second sample part-of-speech tagging result of the training sample spoken text, and a sample modal particle tagging result of the training sample spoken text, where the training sample spoken text is associated with the training sample standard text.

The sample first determination module 820 is used to determine a sample target part-of-speech from the first sample part-of-speech tagging result according to a distribution feature of sample modal particles.

The sample second determination module 830 is used to determine a sample predicted insertion position according to a position of a sample content corresponding to the sample target part-of-speech in the training sample standard text.

The sample mask module 840 is used to mask the sample predicted insertion position in the training sample standard text to obtain a training sample masked standard text, where the training sample masked standard text has the first sample part-of-speech tagging result.

The training module 850 is used to train an initial speech text generation model using a target training set to obtain a trained speech text generation model, where the target training set includes the training sample masked standard text, the second sample part-of-speech tagging result of the training sample spoken text, and the sample modal particle tagging result of the training sample spoken text.

According to embodiments of the present disclosure, the apparatus of training the speech text generation model may further include: a sample updating module and a sample constructing module.

The sample updating module is used to update a first sample standard text in a first sample set and a first sample spoken text in the first sample set by using a sample confusion word in a sample confusion dictionary, so as to obtain a second sample set including a second sample standard text and a second sample spoken text, where the first sample spoken text is associated with the first sample standard text.

The sample constructing module is used to construct the training sample set based on the first sample set and the second sample set.

According to embodiments of the present disclosure, the apparatus of training the speech text generation model may further include: a corpus processing module, a recognition module, and a confusion dictionary construction module.

The corpus processing module is used to process a sample standard corpus text using a speech synthesis apparatus to obtain a sample speech corpus.

The recognition module is used to perform a speech recognition on the sample speech corpus to obtain a sample confusion corpus text.

The confusion dictionary construction module is used to construct the sample confusion dictionary based on the sample standard corpus text and the sample confusion corpus text.

According to embodiments of the present disclosure, the apparatus of training the speech text generation model may further include: a sample initial corpus acquisition module, a sample corpus tagging module and a sample third determination module.

The sample initial corpus acquisition module is used to acquire a sample initial corpus set, where the sample initial corpus set includes a sample initial spoken corpus text generated according to a sample spoken speech corpus.

The sample corpus tagging module is used to perform a part-of-speech tagging on the sample initial spoken corpus text to obtain a sample spoken corpus part-of-speech tagging result and a sample spoken corpus modal particle tagging result.

The sample third determination module is used to determine the distribution feature of sample modal particles according to the sample spoken corpus part-of-speech tagging result and the sample spoken corpus modal particle tagging result.

It should be noted that the part of the apparatus of training the speech text generation model in embodiments of the present disclosure corresponds to the part of the method of training the speech text generation model in embodiments of the present disclosure. The description of the part of the apparatus of training the speech text generation model specifically refers to the part of the method of training the speech text generation model, which will not be repeated here.

Any number of modules, sub-modules, units, sub-units, or at least part of the function of any number thereof according to embodiments of the present disclosure may be implemented in one module. Any one or more of the modules, sub-modules, units, and sub-units according to embodiments of the present disclosure may be divided into a plurality of modules for implementation. Any one or more of the modules, sub-modules, units, sub-units according to embodiments of the present disclosure may be implemented at least partially as a hardware circuit, such as a field programmable gate array (FPGA), a programmable logic array (PLA), a system on a chip, a system on a substrate, a system on a package, an application specific integrated circuit (ASIC), or may be implemented by any other reasonable means of hardware or firmware that integrates or packages a circuit, or may be implemented in any one of or a suitable combination of three implementation methods of software, hardware, and firmware. Alternatively, one or more of the modules, sub-modules, units, and sub-units according to embodiments of the present disclosure may be implemented at least partially as a computer program module, which when executed, may perform a corresponding function.

For example, any number of the tagging module 710, the first determination module 720, the second determination module 730, the insertion module 740 and the generation module 750 may be combined into one module to be implemented or any one of the modules may be divided into a plurality of modules. Alternatively, at least part of the function of one or more of these modules may be combined with at least part of the function of other modules and implemented in one module. According to embodiments of the present disclosure, at least one of the tagging module 710, the first determination module 720, the second determination module 730, the insertion module 740 or the generation module 750 may be implemented at least partially as a hardware circuit, such as a field programmable gate array (FPGA), a programmable logic array (PLA), a system on a chip, a system on a substrate, a system on a package, an application specific integrated circuit (ASIC), or may be implemented by any other reasonable means of hardware or firmware that integrates or packages a circuit, or may be implemented in any one of or a suitable combination of three implementation methods of software, hardware and firmware. Alternatively, at least one of the tagging module 710, the first determination module 720, the second determination module 730, the insertion module 740 or the generation module 750 may be implemented at least partially as a computer program module, which when executed, may perform a corresponding function.

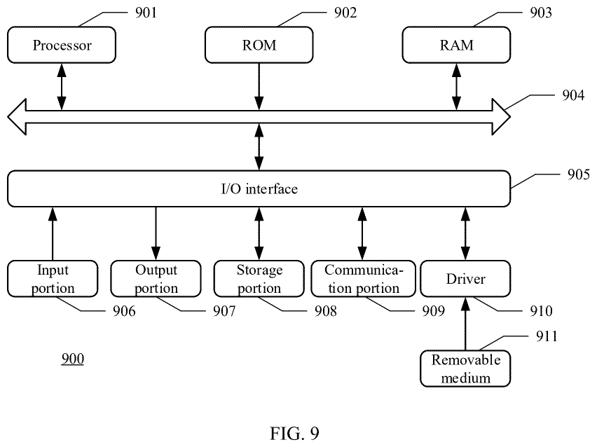

FIG. 9 schematically shows a block diagram of an electronic device suitable for implementing a speech text generation method and a method of training a speech text generation model according to embodiments of the present disclosure. The electronic device shown in FIG. 9 is only an example and should not limit the function and scope of use of embodiments of the present disclosure.

As shown in FIG. 9, the electronic device 900 according to embodiments of the present disclosure includes a processor 901 that may perform various appropriate actions and processes according to programs stored in a read-only memory (ROM) 902 or programs loaded from the storage portion 908 into a random access memory (RAM) 903. The processor 901 may include, for example, a general-purpose microprocessor (e.g., a CPU), an instruction set processor and/or a related chipset and/or a special-purpose microprocessor (e.g., an application-specific integrated circuit (ASIC)), etc. The processor 901 may further include an on-board memory for caching purposes. The processor 901 may include a single processing unit or a plurality of processing units for performing different actions of a method flow according to embodiments of the present disclosure.

In the RAM 903, various programs and data required for the operation of the device 900 are stored. The processor 901, the ROM 902 and the RAM 903 are connected to each other through a bus 904. The processor 901 performs various operations of the method flow according to embodiments of the present disclosure by executing the programs in the ROM 902 and/or the RAM 903. It should be noted that the programs may also be stored in one or more memories other than the ROM 902 and the RAM 903. The processor 901 may also perform various operations of the method flow according to embodiments of the present disclosure by executing the programs stored in the one or more memories.

According to embodiments of the present disclosure, the electronic device 900 may further include an input/output (I/O) interface 905, and the input/output (I/O) interface 905 is also connected to the bus 904. The device 900 may further include one or more of the following components connected to the I/O interface 905: an input portion 906 including a keyboard, a mouse, etc. ; an output portion 907 including a cathode ray tube (CRT), a liquid crystal display (LCD), etc., and a speaker, etc. ; a storage portion 908 including a hard disk, etc. ; and a communication portion 909 including a network interface card such as a LAN card, a modem, etc. The communication portion 909 performs communication processing via a network such as the Internet. A drive 910 is also connected to the I/O interface 905 as needed. A removable medium 911, such as a magnetic disk, an optical disk, a magneto-optical disk, a semiconductor memory, etc., is mounted on the drive 910 as needed so that a computer program read therefrom is installed into the storage portion 908 as needed.

According to embodiments of the present disclosure, the method flow according to embodiment of the present disclosure may be implemented as a computer software program. For example, the embodiment of the present disclosure includes a computer program product including a computer program carried on a computer-readable storage medium, and the computer program contains program code for performing the method illustrated in the flowchart. In such an embodiment, the computer program may be downloaded from the network via the communication portion 909 and installed, and/or installed from the removable medium 911. The computer program, when executed by the processor 901, performs the functions described above defined in the system of embodiments of the present disclosure. According to embodiments of the present disclosure, the system, device, apparatus, module, unit, etc. described above may be implemented by the computer program module.

The present disclosure further provides a computer-readable medium. The computer-readable medium may be included in the device/apparatus/system described in the above embodiments, and may also exist alone without being assembled into the device/apparatus/system. The computer-readable medium described above carries one or more programs, and when the one or more programs are executed, the methods according to embodiments of the present disclosure may be implemented.

According to embodiments of the present disclosure, the computer-readable medium may be a nonvolatile computer-readable storage medium. The computer-readable storage medium may include, for example, but are not limited to, a portable computer disk, a hard disk, a random access memory (RAM), a read only memory (ROM), an erasable programmable read only memory (EPROM or flash memory), a portable compact disk read only memory (CD-ROM), an optical storage apparatus, a magnetic storage apparatus, or any suitable combination of the above. In the present disclosure, the computer-readable storage medium may be any tangible medium that contains or stores a program that may be used by or in conjunction with an instruction execution system, apparatus, or apparatus.

For example, according to embodiments of the present disclosure, the computer-readable medium may include one or more memories other than the ROM 902 and/or the RAM 903 and/or the ROM 902 and the RAM 903 described above.

Embodiments of the present disclosure further include a computer program product, which includes a computer program, the computer program includes a program code for executing the methods provided by embodiments of the present disclosure, and when the computer program product is run on an electronic device, the program code is used to enable the electronic device to implement the above methods provided by embodiments of the present disclosure.

When the computer program is executed by the processor 901, the above functions defined in the system/device of the embodiment of the present disclosure are executed. According to the embodiment of the present disclosure, the system, device, module, unit, etc. described above can be implemented by a computer program module.

In an embodiment, the computer program can rely on a tangible storage medium such as an optical storage device or a magnetic storage device. In another embodiment, the computer program can also be transmitted and distributed in the form of a signal on a network medium, and downloaded and installed through the communication part 909, and/or installed from a removable medium 911. The program code contained in the computer program can be transmitted using any appropriate network medium, including but not limited to: wireless, wired, etc., or any suitable combination of the above.

According to embodiments of the present disclosure, the program code for executing the computer program provided by the embodiment of the present disclosure can be written in any combination of one or more programming languages. Specifically, these computing programs can be implemented using high-level process and/or object-oriented programming languages, and/or assembly/machine languages. Programming languages include, but are not limited to, Java, C++, python, “C” language or similar programming languages. The program code can be executed entirely on the user computing device, partially on the user device, partially on the remote computing device, or entirely on the remote computing device or server. In the case of a remote computing device, the remote computing device can be connected to the user computing device through any type of network, including a local area network (LAN) or a wide area network (WAN), or can be connected to an external computing device (for example, using an Internet service provider to connect through the Internet).

The flowcharts and block diagrams in the drawings illustrate the possible implementation architecture, functions, and operations of the system, method and computer program product according to various embodiments of the present disclosure. In this regard, each block in the flowchart or block diagram may represent a module, program segment, or part of codes, and the above mentioned module, program segment, or part of codes contains one or more executable instructions for implementing specified logic function. It should also be noted that, in some alternative implementations, the functions marked in the block may also occur in a different order from the order marked in the drawings. For example, two blocks shown in succession may actually be executed substantially in parallel, and the blocks may sometimes be executed in a reversed order, depending on the functions involved. It should also be noted that each block in the block diagram or flowchart, and the combination of blocks in the block diagram or flowchart, may be implemented by a dedicated hardware-based system that performs the specified functions or operations, or may be implemented by a combination of dedicated hardware and computer instructions. Those skilled in the art may understand that the features described in the various embodiments of the present disclosure and/or the claims may be combined and/or incorporated in various ways, even if such combinations or incorporations are not explicitly described in the present disclosure. In particular, without departing from the spirit and teachings of the present disclosure, the various embodiments of the present disclosure and/or the features described in the claims may be combined and/or incorporated in various ways. All these combinations and/or incorporations fall within the scope of the present disclosure.

Embodiments of the present disclosure have been described above. However, these examples are for illustrative purposes only, and are not intended to limit the scope of the present disclosure. Although the various embodiments are described above separately, this does not mean that the measures in the various embodiments may not be advantageously used in combination. The scope of the present disclosure is defined by the appended claims and their equivalents. Without departing from the scope of the present disclosure, those skilled in the art may make various substitutions and modifications, and these substitutions and modifications should all fall within the scope of the present disclosure.

1. A speech text generation method, comprising:
performing a part-of-speech tagging on a standard text to obtain a part-of-speech tagging result;
determining a target part-of-speech from the part-of-speech tagging result according to a distribution feature of modal particles;
determining a predicted insertion position according to a position of a content corresponding to the target part-of-speech in the standard text;
inserting a target modal particle into the standard text according to the predicted insertion position to obtain a target spoken text; and
generating a target speech text according to the target spoken text.

2. The speech text generation method according to claim 1, wherein the inserting a target modal particle into the standard text according to the predicted insertion position to obtain a target spoken text comprises:
masking the predicted insertion position of the standard text to obtain a masked standard text; and
inputting the masked standard text into a speech text generation model, so that the speech text generation model inserts the target modal particle at a target insertion position in the predicted insertion position to generate the target spoken text.

3. The speech text generation method according to claim 1, further comprising:
acquiring an initial corpus set, wherein the initial corpus set comprises an initial spoken corpus text generated based on a spoken speech corpus;
performing a part-of-speech tagging on the initial spoken corpus text to obtain a spoken corpus part-of-speech tagging result and a spoken corpus modal particle tagging result; and
determining the distribution feature of modal particles based on the spoken corpus part-of-speech tagging result and the spoken corpus modal particle tagging result.

4. The speech text generation method according to claim 1, wherein the performing a part-of-speech tagging on a standard text to obtain a part-of-speech tagging result comprises:
inputting the standard text into a semantic recognition model to obtain the part-of-speech tagging result;
wherein the semantic recognition model comprises:
a first semantic recognition model constructed based on a recurrent neural network model and a conditional random field model; or
a second semantic recognition model constructed based on a dependency syntactic parsing.

5. A method of training a speech text generation model, comprising:
performing a part-of-speech tagging on a training sample standard text in a training sample set and a training sample spoken text in the training sample set, so as to obtain a first sample part-of-speech tagging result of the training sample standard text, a second sample part-of-speech tagging result of the training sample spoken text, and a sample modal particle tagging result of the training sample spoken text, wherein the training sample spoken text is associated with the training sample standard text;
determining a sample target part-of-speech from the first sample part-of-speech tagging result according to a distribution feature of sample modal particles;
determining a sample predicted insertion position according to a position of a sample content corresponding to the sample target part-of-speech in the training sample standard text;
masking the sample predicted insertion position in the training sample standard text to obtain a training sample masked standard text, wherein the training sample masked standard text has the first sample part-of-speech tagging result; and
training an initial speech text generation model using a target training set to obtain a trained speech text generation model, wherein the target training set comprises the training sample masked standard text, the second sample part-of-speech tagging result of the training sample spoken text, and the sample modal particle tagging result of the training sample spoken text.

6. The method according to claim 5, further comprising:
updating a first sample standard text in a first sample set and a first sample spoken text in the first sample set by using a sample confusion word in a sample confusion dictionary, so as to obtain a second sample set comprising a second sample standard text and a second sample spoken text, wherein the first sample spoken text is associated with the first sample standard text; and
constructing the training sample set based on the first sample set and the second sample set.

7. The method according to claim 6, further comprising:
processing a sample standard corpus text using a speech synthesis apparatus to obtain a sample speech corpus;
performing a speech recognition on the sample speech corpus to obtain a sample confusion corpus text; and
constructing the sample confusion dictionary based on the sample standard corpus text and the sample confusion corpus text.

8. The method according to claim 5, further comprising:
acquiring a sample initial corpus set, wherein the sample initial corpus set comprises a sample initial spoken corpus text generated according to a sample spoken speech corpus;
performing a part-of-speech tagging on the sample initial spoken corpus text to obtain a sample spoken corpus part-of-speech tagging result and a sample spoken corpus modal particle tagging result; and
determining the distribution feature of sample modal particles according to the sample spoken corpus part-of-speech tagging result and the sample spoken corpus modal particle tagging result.

9-10. (canceled)

11. An electronic device, comprising:
one or more processors; and
a memory configured to store one or more programs,
wherein the one or more programs, when executed by the one or more processors, are configured to cause the one or more processors to
perform a part-of-speech tagging on a standard text to obtain a part-of-speech tagging result;
determine a target part-of-speech from the part-of-speech tagging result according to a distribution feature of modal particles;
determine a predicted insertion position according to a position of a content corresponding to the target part-of-speech in the standard text;
insert a target modal particle into the standard text according to the predicted insertion position to obtain a target spoken text; and
generate a target speech text according to the target spoken text.

12. A non-transitory computer-readable storage medium having executable instructions therein, wherein the instructions, when executed by a processor, are configured to cause the processor to implement the method of claim 1.

13. (canceled)

14. The electronic device according to claim 11, wherein the one or more programs are further configured to cause the one or more processors to at least:
mask the predicted insertion position of the standard text to obtain a masked standard text; and
input the masked standard text into a speech text generation model, so that the speech text generation model inserts the target modal particle at a target insertion position in the predicted insertion position to generate the target spoken text.

15. The electronic device according to claim 11, wherein the one or more programs are further configured to cause the one or more processors to at least:
acquire an initial corpus set, wherein the initial corpus set comprises an initial spoken corpus text generated based on a spoken speech corpus;
perform a part-of-speech tagging on the initial spoken corpus text to obtain a spoken corpus part-of-speech tagging result and a spoken corpus modal particle tagging result; and
determine the distribution feature of modal particles based on the spoken corpus part-of-speech tagging result and the spoken corpus modal particle tagging result.

16. The electronic device according to claim 11, wherein the one or more programs are further configured to cause the one or more processors to at least:
input the standard text into a semantic recognition model to obtain the part-of-speech tagging result;
wherein the semantic recognition model comprises:
a first semantic recognition model constructed based on a recurrent neural network model and a conditional random field model; or
a second semantic recognition model constructed based on a dependency syntactic parsing.

17. An electronic device, comprising:
one or more processors; and
a memory configured to store one or more programs,
wherein the one or more programs, when executed by the one or more processors, are configured to cause the one or more processors to implement the method of claim 5.

18. The electronic device according to claim 17, wherein the one or more programs are further configured to cause the one or more processors to at least:
update a first sample standard text in a first sample set and a first sample spoken text in the first sample set by using a sample confusion word in a sample confusion dictionary, so as to obtain a second sample set comprising a second sample standard text and a second sample spoken text, wherein the first sample spoken text is associated with the first sample standard text; and
construct the training sample set based on the first sample set and the second sample set.

19. The electronic device according to claim 18, wherein the one or more programs are further configured to cause the one or more processors to at least:
process a sample standard corpus text using a speech synthesis apparatus to obtain a sample speech corpus;
perform a speech recognition on the sample speech corpus to obtain a sample confusion corpus text; and
construct the sample confusion dictionary based on the sample standard corpus text and the sample confusion corpus text.

20. The electronic device according to claim 17, wherein the one or more programs are further configured to cause the one or more processors to at least:
acquire a sample initial corpus set, wherein the sample initial corpus set comprises a sample initial spoken corpus text generated according to a sample spoken speech corpus;
perform a part-of-speech tagging on the sample initial spoken corpus text to obtain a sample spoken corpus part-of-speech tagging result and a sample spoken corpus modal particle tagging result; and
determine the distribution feature of sample modal particles according to the sample spoken corpus part-of-speech tagging result and the sample spoken corpus modal particle tagging result.

21. The non-transitory computer-readable storage medium according to claim 12, wherein the instructions are further configured to cause the processor to at least:
mask the predicted insertion position of the standard text to obtain a masked standard text; and
input the masked standard text into a speech text generation model, so that the speech text generation model inserts the target modal particle at a target insertion position in the predicted insertion position to generate the target spoken text.

22. The non-transitory computer-readable storage medium according to claim 12, wherein the instructions are further configured to cause the processor to at least:
acquire an initial corpus set, wherein the initial corpus set comprises an initial spoken corpus text generated based on a spoken speech corpus;
perform a part-of-speech tagging on the initial spoken corpus text to obtain a spoken corpus part-of-speech tagging result and a spoken corpus modal particle tagging result; and
determine the distribution feature of modal particles based on the spoken corpus part-of-speech tagging result and the spoken corpus modal particle tagging result.

23. A non-transitory computer-readable storage medium having executable instructions therein, wherein the instructions, when executed by a processor, are configured to cause the processor to implement the method of claim 5.
